(19) United States
(12) Patent Application Publication
(10) Pub. No.: US 2024/0303918 A1
(43) Pub. Date: Sep. 12, 2024

(54) GENERATING REPRESENTATION OF USER BASED ON DEPTH MAP

(71) Applicant: GOOGLE LLC, Mountain View, CA (US)

(72) Inventors: Ruofei Du, San Francisco, CA (US); Xun Qian, Mountain View, CA (US); Yinda Zhang, Palo Alto, CA (US); Alex Olwal, Santa Cruz, CA (US)

(21) Appl. No.: 18/484,783

(22) Filed: Oct. 11, 2023

Related U.S. Application Data
(63) Continuation-in-part of application No. PCT/US2023/063948, filed on Mar. 8, 2023.

(51) Int. Cl. G06T 17/00; G06T 7/55; G06T 7/73

(52) U.S. Cl. CPC G06T 17/00; G06T 7/55; G06T 7/73; G06T 2207/10016; G06T 2207/10024; G06T 2207/20081; G06T 2207/30201; G06T 2210/22; H04N 23/611

(57) ABSTRACT

A method can include receiving, via a camera, a first video stream of a face of a user; determining a location of the face of the user based on the first video stream and a facial landmark detection model; receiving, via the camera, a second video stream of the face of the user; generating a depth map based on the second video stream, the location of the face of the user, and a depth prediction model; and generating a representation of the user based on the depth map and the second video stream.

### CROSS REFERENCE TO RELATED APPLICATION

This application is a continuation-in-part of, and claims the benefit of, PCT Application No. PCT/US2023/063948, filed Mar. 8, 2023, the disclosure of which is incorporated herein by reference in its entirety.

### TECHNICAL FIELD

This description relates to videoconferencing.

### BACKGROUND

Users can engage in videoconferencing with persons who are in remote locations via computing devices that include cameras, microphones, displays, and speakers.

### SUMMARY

A computing device can receive a video stream of a local user and generate a depth map based on the video stream. The computing device can generate a representation of the user based on the depth map and the video stream. The representation can include a video representing the local user's face, and can include head movement, eye movement, mouth movement, and/or facial expressions. The computing device can send the representation to a remote computing device for viewing by a remote user with whom the local user is communicating via videoconference.

In some aspects, the techniques described herein relate to a method including receiving, via a camera, a first video stream of a face of a user; determining a location of the face of the user based on the first video stream and a facial landmark detection model; receiving, via the camera, a second video stream of the face of the user; generating a depth map based on the second video stream, the location of the face of the user, and a depth prediction model; and generating a representation of the user based on the depth map and the second video stream.

In some examples, the method includes receiving, via a camera, a video stream of a face of a user; generating a depth map based on the video stream, a location of the face of the user, and a neural network; and generating a representation of the user based on the depth map and the video stream.

In some aspects, the techniques described herein relate to a method including receiving, via a camera, a video stream of a face of a user; generating a depth map based on the video stream, a location of the face of the user, and a neural network; and generating a representation of the user based on the depth map and the video stream.

In some aspects, the techniques described herein relate to a non-transitory computer-readable storage medium including instructions stored thereon. When executed by at least one processor, the instructions are configured to cause a computing device to receive, via a camera, a first video stream of a face of a user; determine a location of the face of the user based on the first video stream and a facial landmark detection model; receive, via the camera, a second video stream of the face of the user; generate a depth map based on the second video stream, the location of the face of the user, and a depth prediction model; and generate a representation of the user based on the depth map and the second video stream.

In some aspects, the techniques described herein relate to a non-transitory computer-readable storage medium including instructions stored thereon. When executed by at least one processor, the instructions are configured to cause a computing device to receive, via a camera, a video stream of a face of a user; generate a depth map based on the video stream, a location of the face of the user, and a neural network; and generate a representation of the user based on the depth map and the video stream.

In some aspects, the techniques described herein relate to a computing device comprising at least one processor and a non-transitory computer-readable storage medium comprising instructions stored thereon. When executed by the at least one processor, the instructions are configured to cause the computing device to receive, via a camera, a first video stream of a face of a user; determine a location of the face of the user based on the first video stream and a facial landmark detection model; receive, via the camera, a second video stream of the face of the user; generate a depth map based on the second video stream, the location of the face of the user, and a depth prediction model; and generate a representation of the user based on the depth map and the second video stream.

In some aspects, the techniques described herein relate to a computing device comprising at least one processor and a non-transitory computer-readable storage medium comprising instructions stored thereon. When executed by the at least one processor, the instructions are configured to cause the computing device to receive, via a camera, a video stream of a face of a user; generate a depth map based on the video stream, a location of the face of the user, and a neural network; and generate a representation of the user based on the depth map and the video stream.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram showing a local user communicating with a remote user via videoconference.

FIG. 1B is a diagram showing a representation of the local user.

FIG. 1C shows a display with representations of multiple users who are participating in the videoconference.

FIG. 2 is a block diagram of a pipeline for generating a representation of the local user based on a depth map.

FIG. 3 is a diagram that includes a neural network for generating a depth map.

FIG. 4 shows a depth camera and a camera capturing images of a person to train the neural network.

FIG. 5 shows a pipeline for rendering the representation of the local user.

FIG. 6 is a block diagram of a computing device that generates a representation of the local user based on the depth map.

FIG. 7 is a flowchart showing a method performed by a computing device.

FIG. 8 is a flowchart showing another method performed by a computing device.

FIG. 9A shows a portrait depth estimation model.

FIG. 9B shows a resblock, included in the portrait depth estimation model of FIG. 9A, in greater detail.

Like reference numbers refer to like elements.

### DETAILED DESCRIPTION

Videoconferencing systems can send video streams of users to other users. However, these video streams can require large amounts of data. The large amounts of data required to send data streams can create difficulties, particularly when relying on a wireless network.

To reduce data required for videoconferencing, a computing device can generate a depth map based on the video stream, and generate a representation of a local user based on the depth map and the video stream. The representation of the local user can include a three-dimensional (3D) avatar generated in real time that includes head movement, eye movement, mouth movement, and/or facial expressions corresponding to such movements by the local user.

The computing device can generate the depth map based on a depth prediction model. The depth prediction model may have been previously trained based on images, for example same images, of persons captured by both a depth camera and a color (such as red-green-blue (RGB)) camera. The depth prediction model can include a neural network that was trained based on images of persons captured by both the depth camera and the color camera.

The computing device can generate the depth map based on the depth prediction model and a single color (such as red-green-blue (RGB)) camera. The generation of the depth map based on the depth prediction model and the single color camera reduces the hardware needed to generate the representation (e.g., a 3D representation) of the local user. The generation of the depth map based on the depth prediction model and the single color camera reduces the hardware needed to generate the representation of the local user for viewing by a remote user in, for example, a video conference with the local user. In other words, multiple cameras capturing images of the local user (e.g., multiple cameras from different perspectives capturing images of the local user) may not be needed to produce a 3D representation of the local user for viewing by, for example, a remote user.

The computing device can send the representation of the local user to one or more remote computing devices. The representation can realistically represent the user while relying on less data than an actual video stream of the local user. In some examples, a plugin for a web browser can implement the methods, functions, and/or techniques described herein.

The representation of the local user can be a three-dimensional representation of the local user. The three-dimensional representation of the local user can be valuable in the context of virtual reality (VR) and/or augmented reality (AR) glasses, because the remote computing device can rotate the three-dimensional representation of the local user in response to movement of the VR and/or AR glasses. For example, a single camera can be used to capture a local user and a 3D representation of the local user can be generated for viewing a remote user using, for example, VR (e.g., a VR head mounted display) and/or AR glasses.

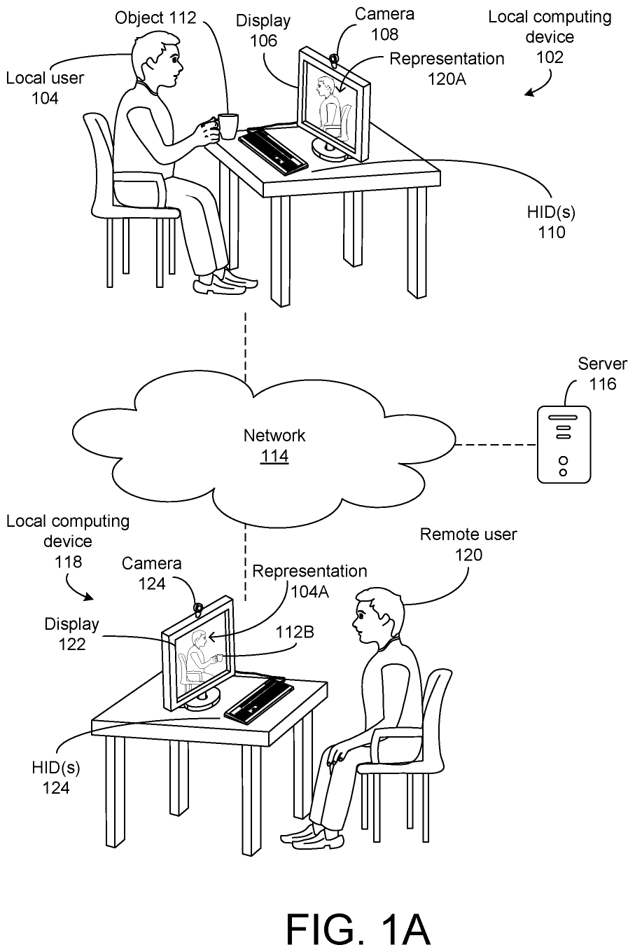

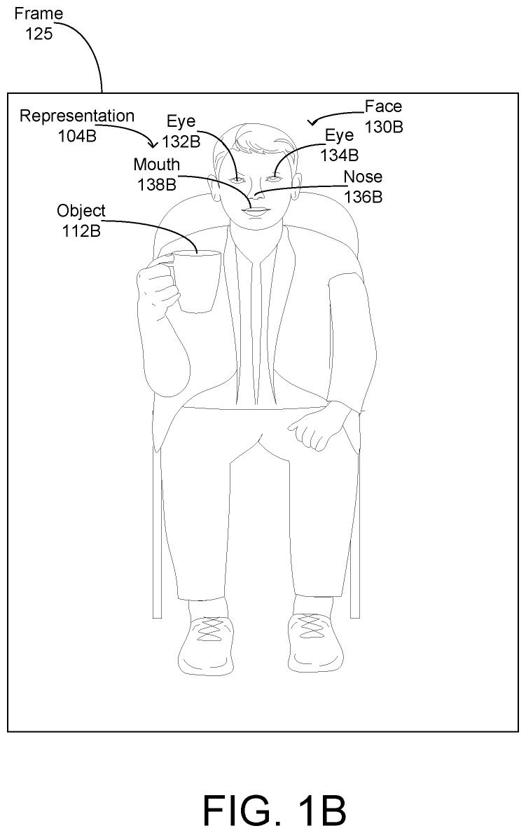

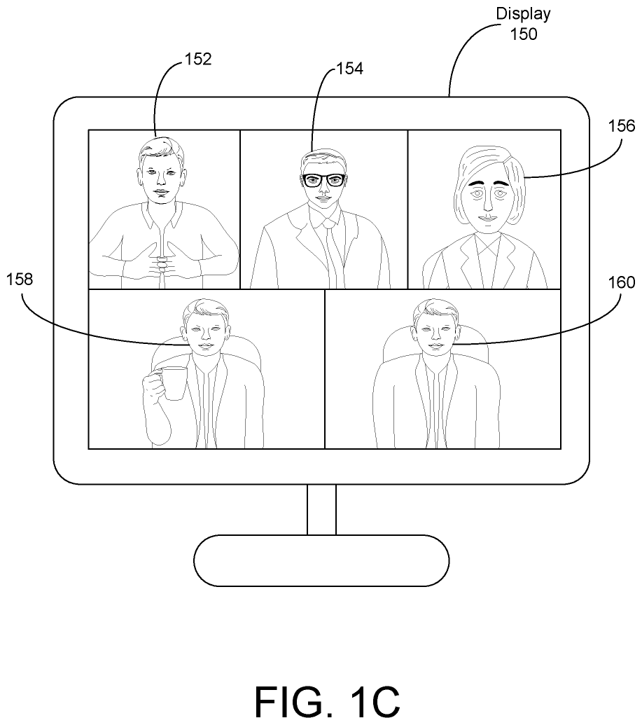

FIG. 1A is a diagram showing a local user 104 communicating with a remote user 120 via videoconference. A local computing device 102 can capture a video stream of the local user 104, generate a depth map based on the video stream, and generate a representation of the user based on the depth map. The local computing device 102 can send the representation of the local user 104 to a remote computing device 118 for viewing by the remote user 120.

The local user 104 is interacting with the local computing device 102. The local user 104 may be logged into the local computing device 102 with an account associated with the local user 104. The remote user 120 is interacting with the remote computing device 118. The remote user 120 may be logged into the remote computing device 118 with an account associated with the remote computing device 118.

The local computing device 102 can include a camera 108. The camera 108 can capture a video stream of the local user 104. The camera 108 can capture a video stream of a face of the local user 104. The camera 108 can capture a video stream of the face of the local user 104 and/or other portions of a body of the local user 104. In some examples, the camera 108 can capture a video stream of the face of the local user 104, other portions of the body of the local user 104, and/or objects 112 held by and/or in contact with the local user 104, such as a coffee mug. In some examples, the local computing device 102 includes only a single camera 108. In some examples, the local computing device 102 includes only a single color (such as red-green-blue (RGB)) camera 108. In some examples, the local computing device 102 captures only a single video stream (which can be analyzed at different starting and ending points for a first video stream, a second video stream, and/or a third video stream) with only a single color camera. In some examples, the local computing device 102 does not include more than one color camera.

The local computing device 102 can include a display 106. The display 106 can present graphical output to the local user 104. The display 106 can present a representation 120A of the remote user 120 to the local user 104. In some examples, the representation 120A does not include the chair on which the remote user 120 is sitting. The local computing device 102 can also include a speaker (not shown in FIG. 1A) that provides audio output to the local user 104, such as voice output initially generated by the remote user 120 during the videoconference. The local computing device 102 can include one or more human-interface devices (HID(s)) 110, such as a keyboard and/or trackpad, that receive and/or process input from the local user 104.

The remote computing device 118 can also include a display 122. The display 122 can present graphical output to the remote user 120, such as representations 104A, 112B of the local user 104 and/or objects 112 held by and/or in contact with the local user 104. The remote computing device 118 can include a camera 124 that captures images in a similar manner to the camera 108. The remote computing device 118 can include a speaker (not shown in FIG. 1A) that provides audio output to the remote user 120, such as voice output initially generated by the local user 104 during the videoconference. The remote computing device 118 can include one or more human-interface devices (HID(s)) 124, such as a keyboard and/or trackpad, that receive and/or process input from the remote user 120. While two users 104, 120 and their respective computing devices 102, 118 are shown in FIG. 1A, any number of users can participate in the videoconference.

The local computing device 102 and remote computing device 118 communicate with each other via a network 114, such as the Internet. In some examples, the local computing device 102 and remote computing device 118 communicate with each other via a server 116 that hosts the videoconference. In some examples, the local computing device 102 generates the representation 104A of the local user 104 based on the depth map and sends the representation 104A to the remote computing device 118. In some examples, the local computing device 102 sends the video stream captured by the camera 108 to the server 116, and the server 116 generates the representation 104A based on the depth map and sends the representation 104A to the remote computing device 118. In some examples, the representation 104A does not include the chair on which the local user 104 is sitting.

In some examples, the methods, functions, and/or techniques described herein can be implemented by a plugin installed on a web browser executed in the local computing device 102 and/or remote computing device 118. The plugin could toggle on and off a telepresence feature that generates the representation 104A (which facilitates the videoconference) in response to user input, enabling users 104, 120 to concurrently work on their own tasks while the representation 104A, representation 120A are represented in the videoconference facilitated by the telepresence feature. Screensharing and file sharing can be integrated into the telepresence system. Processing modules such as relighting, filters, and/or visual effects can be embedded in the rendering of the representation 104A, representation 120A.

FIG. 1B is a diagram showing a representation 104B of the local user 104. The representation 104B may have been captured by the camera 108 as part of a video stream captured by the camera 108. The representation 104B can be included in a frame 125 that is part of the video stream. The representation 104B is different than the representation 104A shown in FIG. 1A as being presented by the display 122 of the remote computing device 118 in that the representation 104B shown in FIG. 1B was included in a video stream captured by the camera 108, whereas the representation 104A presented by the display 122 included in the remote computing device 118 shown in FIG. 1A was generated by the local computing device 102 and/or server 116 based on a depth map.

The representation 104B includes a representation of a face 130B of the local user 104. The representation 104B of the face 130B includes facial features such as a representation of the user's 104 right eye 132B, a representation of the user's 104 left eye 134B, a representation of the user's 104 nose 136B, and/or a representation of the user's 104 mouth 138B. The representation 104B can also include a representations 112B of the objects 112 held by the local user 104.

In some examples, the local computing device 102 and/or server 116 determines a location of the face 130B based on a first video stream captured by the camera 108 and a facial landmark detection model. The local computing device 102 and/or server 116 can, for example, determine landmarks in the face 130B, which can also be considered facial features, based on the first video stream and the facial landmark detection model. Based on the determined landmarks, the local computing device 102 and/or server 116 can determine a location of the face 130B within the frame 125. In some examples, the local computing device 102 and/or server 116 crops the image and/or frame 125 based on the determined location of the face 130B. The cropped image can include only the face 130B and/or portions of the frame 125 within a predetermined distance of the face 130B.

In some examples, the local computing device 102 and/or server 116 receives a second video stream of the face of the user 104 for generation of a depth map. The first and second video streams can be generated by the same camera 108 and can have different starting and ending times. In some examples, the first video stream (based on which the location of the face 130B was determined) and second video stream can include overlapping frames, and/or at least one frame included in the first video stream is included in the second video stream. In some examples, the second video stream includes only color values for pixels. In some examples, the second video stream does not include depth data. The local computing device 102 and/or server 116 can generate the representation 104A of the local user 104 based on a depth map and the second video stream. The local computing device 102 and/or server 116 can generate the depth map based on the second video stream, the determined location of the face 130B, and a depth prediction model. The remote computing device 118 and/or server 116 can perform any combination of methods, functions, and/or techniques described herein to generate and send the representation 120A of the remote user 120 to the local computing device 102.

FIG. 1C shows a display 150 with representations 152, 154, 156, 158, 160 of multiple users who are participating in the videoconference. The users who are participating in the videoconference can include one or both of the local user 104 and/or the remote user 120. The representations 152, 154, 156, 158, 160 can include one or both of the representation 104A of the local user 104 and/or the representation 120A of the remote user 120. In the example shown in FIG. 1C, the representation 158 corresponds to the representation 104A. In some example, display 150 can present the representations 152, 154, 156, 158, 160 in a single row and/or in front of a singular scene, as if the users represented by the representations 152, 154, 156, 158, 160 are gathered together in a shared meeting space.

The display 150 could include either of the displays 106, 122, or a display included in a computer used by a person other than the local user 104 or the remote user 120. The representations 152, 154, 156, 158, 160 may have been generated based on video streams and/or images captured via different platforms, such as mobile phone, laptop computer, or tablet, a non-limiting examples. The methods, functions, and/or techniques described herein can enable users to participate in the videoconference via different platforms.

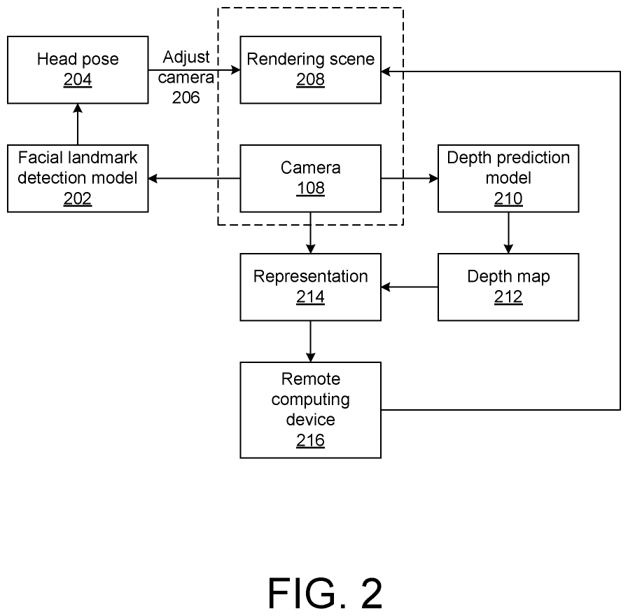

FIG. 2 is a block diagram of a pipeline for generating a representation 104A of the local user 104 based on a depth map. The pipeline can include the camera 108. The camera 108 can capture images of the local user 104. The camera 108 can capture images of the face and/or other body parts of the local user 104 (such as the representation 104B and/or face 130B shown in FIG. 1B) and/or any objects, such as the object 112 held by and/or in contact with the local user 104. The camera 108 can capture images and/or photographs that are included in a video stream of the face 130B of the local user 104.

The camera 108 can send a first video stream to a facial landmark detection model 202. The facial landmark detection model 202 can be included in the local computing device 102 and/or the server 116. The facial landmark detection model 202 can include Shape Preserving with GAts (SPIGA), AnchorFace, Teacher Supervises Students (TS3), or Joint Voxel and Coordinate Regression (JVCR), as non-limiting examples. The facial landmark detection model 202 can determine a location of the face 130B within the frame 125 and/or first video stream. The facial landmark detection model 202 can determine a location of the face 130B based on facial landmarks, which can also be referred to as facial features of the user, such as the right eye 132B, eye 134B, nose 136B, and/or mouth 138B. In some examples, the local computing device 102 and/or server 116 can crop the image and/or frame 125 based on the determined location of the face 130B. The local computing device 102 and/or server 116 can crop the image and/or frame 125 based on the determined location of the face 130B to include only portions of the image and/or frame 125 that are within a predetermined distance of the face 130B and/or within a predetermined distance of predetermined portions (such as chin, cheek, or eyes) of the face 130B.

In some examples, the local computing device 102 and/or server 116 can determine a head pose 204 based on the facial landmarks determined by the facial landmark detection model 202. The head pose 204 can include a direction that the local user 104 is facing and/or a location of a head of the local user 104.

In some examples, the local computing device 102 can adjust the camera 108 (206) and/or the server 116 can instruct the local computing device 102 to adjust the camera 108 (206). The local computing device 102 can adjust the camera 108 (206) by, for example, changing a direction that the camera 108 is pointing and/or by changing a location of focus of the camera 108.

After and/or while adjusting the camera 108, the local computing device 102 can add the images of the local user 104 captured by the camera 108 within the first video stream to a rendering scene 208. The rendering scene 208 can include images and/or representations of the users and/or persons participating in the videoconference, such as the representations 152, 154, 156, 158, 160 of multiple users shown in FIG. 1C. The local computing device 102 need not modify the representation 104B of the local user 104 shown on the display 106 included in the local computing device 102 from the image captured by the first video stream, because representation 104B of the local user 104 shown on the display 106 is captured and rendered locally, obviating the need to reduce the data required to represent the local user 104. The display 106 can present an unmodified representation 104B of the local user 104, as well as representations of remote users received from remote computing devices 118 and/or the server 116. The representations of remote users received from remote computing devices 118 and/or the server 116 and presented by and/or on the display 106 can be modified representations of the images captured by cameras included in the remote computing devices 118 to reduce the data required to transmit the images.

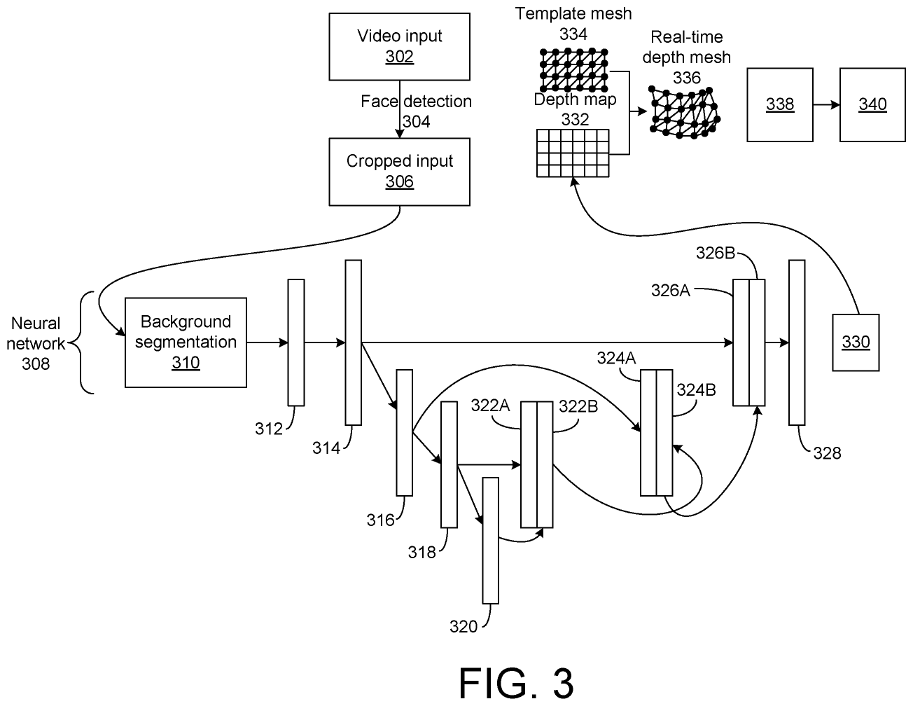

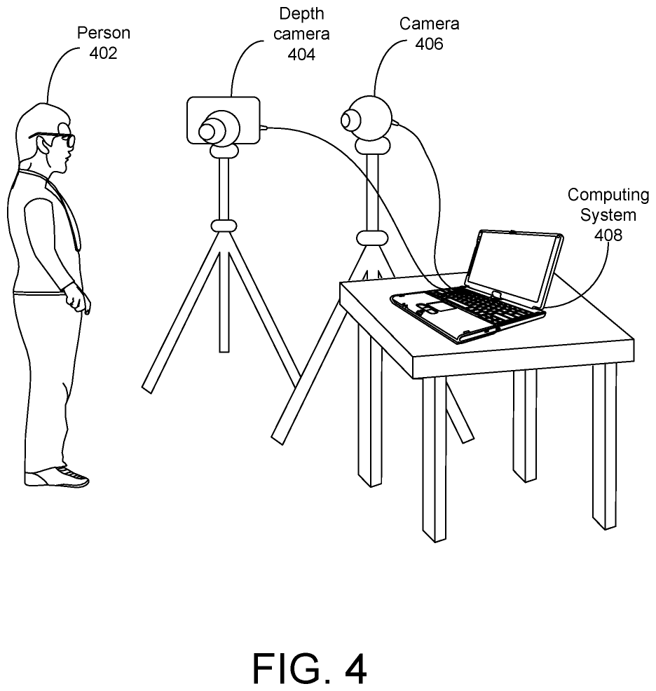

The camera 108 can send a second video stream to a depth prediction model 210. The second video stream can include a representation of the face 130B of the local user 104. The depth prediction model 210 can create a three-dimensional model of the face of the local user 104, as well as other body parts and/or objects held by and/or in contact with the local user 104. The three-dimensional model created by the depth prediction model 210 can be considered a depth map 212, discussed below. In some examples, the depth prediction model 210 can include a neural network model. An example neural network model that can be included in the depth prediction model 210 is shown and described with respect to FIG. 3. In some examples, the depth prediction model 210 can be trained by capturing simultaneous and/or concurrent images of persons with both a depth camera and a color (such as red-green-blue (RGB)) camera. An example of training the depth prediction model 210 by capturing simultaneous and/or concurrent images of persons with both a depth camera and a color camera is shown and described with respect to FIG. 4.

The depth prediction model 210 can generate a depth map 212 based on the second video stream. The depth map 212 can include a three-dimensional representation of portions of the local user 104 and/or any objects 112 held by and/or in contact with the local user 104. In some examples, the depth prediction model 210 can generate the depth map 212 by generating a segmented mask using the body segmentation application programming interface (API) of, for example, TensorFlow.js, masking the images and/or frames with the segmented mask, and passing the masked images and/or frames into a Portrait Depth API to obtain the depth map.

In some examples, the depth prediction model 210 can generate the depth map 212 by creating a grid of triangles with vertices. In some examples, the grid is a 256×192×2 grid. In some examples, each cell in the grid includes two triangles. In each triangle, an x value can indicate a value for a horizontal axis within the image and/or frame, a y value can indicate a value for a vertical axis within the image and/or frame, and a z value can indicate a distance from the camera 108. In some examples, the z values are scaled to have values between zero (0) and one (1). In some examples, the depth prediction model 210 can discard, and/or not render, triangles for which a standard deviation of the three z values exceeds a discrepancy threshold, such as 0.1. The discarding and/or not rendering of triangles for which the standard deviation of the three z values exceeds the discrepancy threshold avoids bleeding artifacts between the face 130B and the background included in the frame 125.

The depth map 212 can include distances of various portions of the face and/or other body parts of the local user 104 with respect to the camera 108 and/or distances of various portions of the face and/or other body parts of the local user 104 with respect to each other. In some examples, the depth map 212 is a lower-resolution tensor, such as a 256×192×1 tensor. In some examples, the depth map 212 can include values between zero (0) and one (1) to indicate relative distances from the pixel to the camera 108 that captured the representation 104B of the local user 104, such as zero indicating the closest to the camera 108 and one indicating the farthest from the camera 108. In some examples, the depth map 212 is stored on a graphics processing unit (GPU) and rendered into a GPU buffer. In some examples, the depth map 212 is stored together with the frame 125 for streaming to remote clients, such as the remote computing device 118.

The local computing device 102 and/or server 116 can combine the depth map 212 with the second video stream and/or a third video stream to generate a representation 214 of the local user 104. The representation 214 can include a three-dimensional avatar that looks like the local user 104 and simulates movements by the local user 104. The representation 214 can represent and/or display head movements, eye movements, mouth movements, and/or facial expressions by the local user 104. In some examples, the representation 214 can include a grid of vertices and/or triangles. The cells in the grid can include two triangles with each triangle including three z values indicating distances and/or depths from the camera 108.

The local computing device 102 and/or server 116 can send the representation 214 to a remote computing device 216, such as the remote computing device 118. The remote computing device 216 can present the representation 214 on a display, such as the display 122, included in the remote computing device 216. The remote computing device 216 can also send to the local computing device 102, either directly to the local computing device 102 or via the server 116, a representation of another person participating in the videoconference, such as the representation 120A of the remote user 120. The local computing device 102 can include the representation 120A of the remote user 120 in the rendering scene 208, such as by including the representation 120A in the display 106 and/or display 150.

FIG. 3 is a diagram that includes a neural network 308 for generating a depth map. The methods, functions, and/or modules described with respect to FIG. 3 can be performed by and/or included in the local computing device 102, the server 116, and/or distributed between the local computing device 102 and server 116. The neural network 308 can be trained using both a depth camera and a color (such as RGB) camera as described with respect to FIG. 4.

Video input 302 can be received by the camera 108. The video input 302 can include, for example, high-resolution red-green-blue (RGB) input, such as 1,920 pixels by 720 pixels, received by the camera 108. The video input 302 can include images and/or representations 104B of the local user 104 and background images. The representations 104B of the local user 104 may not be centered within the video input 302. The representations 104B of the local user 104 may be on a left or right side of the video input 302, causing a large portion of the video input 302 to not include any portion of the representations 104B of the local user 104.

The local computing device 102 and/or server 116 can perform face detection 304 on the received video input 302. The local computing device 102 and/or server 116 can perform face detection 304 on the received video input 302 based on a facial landmark detection model 202, as discussed above with respect to FIG. 2. Based on the face detection 304, the local computing device 102 and/or server 116 can crop the images included in the video input 302 to generate cropped input 306. The cropped input 306 can include smaller images and/or frames that include the face 130B and portions of the images and/or frames that are a predetermined distance from the face 130B. In some examples, the cropped input 306 can include lower resolution than the video input 302, such as including low-resolution color (such as RGB) input and/or video, such as 192 pixels by 256 pixels. The lower resolution and/or lower number of pixels of the cropped input 306 can be the result of cropping the video input 302.

The local computing device 102 and/or server 116 can feed the cropped input 306 into the neural network 308. The neural network 308 can perform background segmentation 310. The background segmentation 310 can include segmenting and/or dividing the background into segments and/or parts. The background that is segmented and/or divided can include portions of the cropped input 306 other than the representation 104B of the local user 104, such as a wall and/or chair. In some examples, the background segmentation 310 can include removing and/or cropping the background from the image(s) and/or cropped input 306.

A first layer 312 of the neural network 308 can receive input including the cropped input cropped input 306 and/or the images in the video stream with the segmented background. The input received by the first layer 312 can include low-resolution color input similar to the cropped input 306, such as 256×192×3 RGB input. The first layer 312 can perform a rectified linear activation function (ReLU) on the input received by the first layer 312, and/or apply a three-by-three (3×3) convolutional filter to the input received by the first layer 312. The first layer 312 can output the resulting frames and/or video to a second layer 314.

The second layer 314 can receive the output from the first layer 312. The second layer 314 can apply a three-by-three (3×3) convolutional filter to the output of the first layer 312, to reduce the size of the frames and/or video stream. The size can be reduced, for example, from 256 pixels by 192 pixels to 128 pixels by 128 pixels. The second layer 314 can perform a rectified linear activation function on the reduced frames and/or video stream. The second layer 314 can also perform max pooling on the reduced frames and/or video stream, reducing the dimensionality and/or number of pixels included in the frames and/or video stream. The second layer 314 can output the resulting frames and/or video stream to a third layer 316 and to a first half 326A of an eighth layer.

The third layer 316 can perform additional convolutional filtering (such as three-by-three convolutional filtering), perform a rectified linear activation function, and/or max pooling on the frames and/or video stream received from the second layer 314 to further reduce the dimensionality and/or number of pixels included in the frames and/or video stream. The number of pixels included in the frames and/or video stream can be reduced, for example, from 128 pixels by 128 pixels to 128 pixels by 64 pixels. The third layer 316 can output the resulting frames and/or video stream to a fourth layer 318 and to a first half 324A of a seventh layer.

The fourth layer 318 can perform additional convolutional filtering (such as three-by-three convolutional filtering), perform a rectified linear activation function, and/or max pooling on the frames and/or video stream received from the third layer 316 to further reduce the dimensionality and/or number of pixels included in the frames and/or video stream. The number of pixels included in the frames and/or video stream can be reduced, for example, from 128 pixels by 64 pixels to 64 pixels by 32 pixels. The fourth layer 318 can output the resulting frames and/or video stream to a fifth layer 320 and to a first half 322A of a sixth layer.

The fifth layer 320 can perform additional convolutional filtering (such as three-by-three convolutional filtering), perform a rectified linear activation function, and/or max pooling on the frames and/or video stream received from the fourth layer 318 to further reduce the dimensionality and/or number of pixels included in the frames and/or video stream. The number of pixels included in the frames and/or video stream can be reduced, for example, from 64 pixels by 32 pixels to 32 pixels by 32 pixels. The fifth layer 320 can output the resulting frames and/or video stream to a second half 322B of a sixth layer.

The sixth layer, which includes the first half 322A that received the output from the fourth layer 318 and the second half 322B that received the output from the fifth layer 320, can perform up convolution on the frames and/or video stream to increase the dimensionality and/or number of pixels included in the frames and/or video stream. The up convolution can double the dimensionality and/or number of pixels in each dimension, such as by increasing the number of pixels from 32×32 to 64×(32+32). The sixth layer can output the up-convolved frames and/or video stream to a second half 324B of the seventh layer.

The seventh layer, which includes the first half 324A that received the output from the third layer 316 and the second half 324B that received the output from the second half 322B of the sixth layer, can perform further up convolution on the frames and/or video stream to increase the dimensionality and/or number of pixels included in the frames and/or video stream. The up convolution can double the dimensionality and/or number of pixels in each dimension, such as by increasing the number of pixels from 64×64 to 128×(64+64). The seventh layer can output the up-convolved frames and/or video stream to a second half 326B of the eighth layer.

The eighth layer, which includes the first half 326A that received the output from the second layer 314 and the second half 326B that received the output from the second half 324B of the seventh layer, can perform further up convolution on the frames and/or video stream to increase the dimensionality and/or number of pixels included in the frames and/or video stream. The up convolution can double the dimensionality and/or number of pixels, such as by increasing the number of pixels from 128×128 to 128×(128+128). The eighth layer can output the up-convolved frames and/or video stream to a ninth layer 328.

The ninth layer 328 can receive the output from the eight layer. The ninth layer 328 can perform further up convolution on the frames and/or video stream received from the eighth layer. The ninth layer 328 can also reshape the frames and/or video stream received from the eighth layer. The up-convolving and reshaping performed by the ninth layer 328 can increase the dimensionality and/or pixels in the frames and/or video stream. The frames and/or video stream with the increased dimensionality and/or pixels can represent a silhouette 330 of the local user 104.

The local computing device 102 and/or server 116 can generate a depth map 332 based on the silhouette 330. The depth map can include distances of various portions of the local user 104 and/or objects 112 in contact with and/or held by the local user 104. The distances can be distances from the camera 108 and/or distances and/or directions from other portions of the local user 104 and/or objects 112 in contact with and/or held by the local user 104. The local computing device 102 and/or server 116 can generate the depth map 332 by generating a segmented mask using the body segmentation application programming interface (API) of TensorFlow.js, masking the images and/or frames with the segmented mask, and passing the masked images and/or frames into, for example, a Portrait Depth API to obtain the depth map.

The local computing device 102 and/or server 116 can generate a real-time depth mesh 336 based on the depth map 332 and a template mesh 334. The template mesh 334 can include colors of the representation 104B of the local user 104 captured by the camera 108. The local computing device 102 and/or server 116 can project the colors from the frames onto the triangles within the depth map 332 to generate the real-time depth mesh 336. The real-time depth mesh 336 can include a three-dimensional representation of the local user 104, such as a three-dimensional avatar, that represents the local user 104. The three-dimensional representation of the local user 104 can mimic the movements and facial expressions of the local user 104 in real time.

The local computing device 102 and/or server 116 can generate an image 338, and/or stream of images 338, based on the real-time depth mesh 336. The server 116 and/or remote computing device 118 can add the image 338 and/or stream of images to an image 340 and/or video stream that includes multiple avatars. The image 340 and/or video stream that includes the multiple avatars can include representations of multiple uses, such as the display 150 shown and described with respect to FIG. 1C.

FIG. 4 shows a depth camera 404 and a camera 406 capturing images of a person 402 to train the neural network 308. The depth camera 404 and camera 406 can each capture multiple images and/or photographs of the person 402. The depth camera 404 and camera 406 can capture the multiple images and/or photographs of the person 402 concurrently and/or simultaneously. The images and/or photographs can be captured at multiple angles and/or distances, which can be facilitated by the person 402 rotating portions of the body and/or face of the person 402 and moving toward and away from the depth camera 404 and camera 406. In some examples, the images and/or photographs captured by the depth camera 404 and camera 406 can be timestamped to enable matching the images and/or photographs that were captured at same times. The person 402 can move, changing head poses and/or facial expressions, so that the depth camera 404 and camera 406 capture images of the person 402 (particularly the persons 402 face) from different angles and with different facial expressions.

The depth camera 404 can determine distances to various locations, portions, and/or points on the person 402. In some examples, the depth camera 404 includes a stereo camera, with two cameras that can determine distances based on triangulation. In some examples, the depth camera 404 can include a structured light camera or coded light depth camera that projects patterned light onto the person 402 and determines the distances based on differences between the projected light and the images captured by the depth camera 404. In some examples, the depth camera 404 can include a time of flight camera that sweeps light over the person 402 and determines the distances based on a time between sending the light and capturing the light by a sensor included in the depth camera 404.

The camera 406 can include a color camera, such as a red-green-blue (RGB) camera, that generates a two-dimensional grid of pixels. The camera 406 can generate the two-dimensional grid of pixels based on light captured by a sensor included in the camera 406.

A computing system 408 can receive the depth map from the depth camera 404 and the images (such as grids of pixels) from the camera 406. The computing system 408 can store the depth maps received from the depth camera 404 and the images received from the camera 406 in pairs. The pairs can each include a depth map and an image that capture the person 402 at the same time. The pairs can be considered training data to train the neural network 308. The neural network 308 can be trained by comparing depth data based on images captured by the depth camera 404 to color data based on images captured by the camera 406. The computing system 408, and/or another computing system, can train the neural network 308 based on the training data to determine depth maps based on images that were captured by a color (such as RGB) camera, such as the camera 108 included in the local computing device 102.

The computing system 408, and/or another computing system in communication with the computing system 408, can send the training data, and/or the trained neural network 308, along with software (such as computer-executable instructions), to one or more other computing devices, such as the local computing device 102, server 116, and/or remote computing device 118, enabling the one or more other computing devices to perform any combination of methods, functions, and/or techniques described herein.

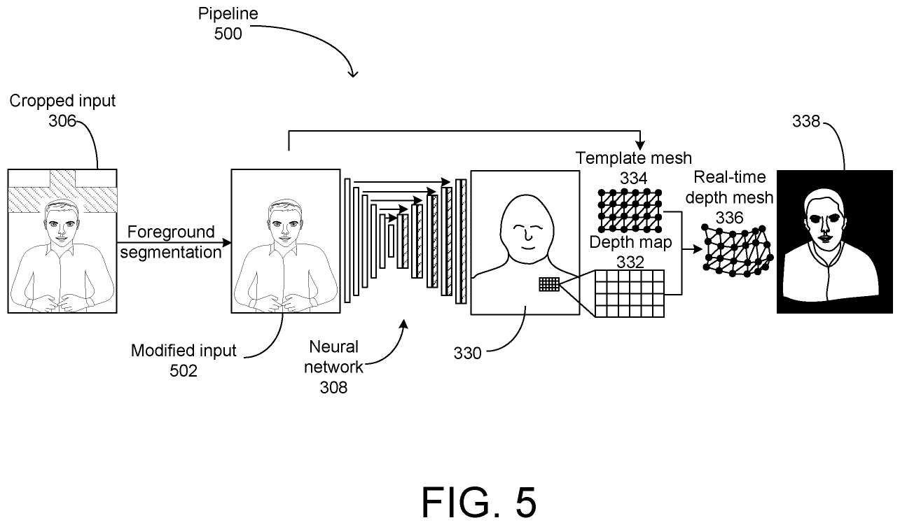

FIG. 5 shows a pipeline 500 for rendering the representation 104B of the local user 104. The cropped input 306 can include a reduced portion of the video input 302, as discussed above with respect to FIG. 3. The cropped input 306 can include a captured image and/or representation of a face of a user and some other body parts, such as the representation 104B of the local user 104. In some examples, the cropped input 306 can include virtual images of users, such as avatars of users, rotated through different angles of view.

The pipeline 500 can include segmenting the foreground to generate a modified input 502. The segmentation of the foreground can result in the background of the cropped input 306 being eliminated in the modified input 502, such as causing the background to be all black or some other predetermined color. The foreground that is eliminated can be parts of the cropped input 306 that are not part of or in contact with the local user 104.

The pipeline 500 can pass the modified input 502 to the neural network 308. The neural network 308 can generate the silhouette 330 based on the modified input 502. The neural network 308 can also generate the depth map 332 based on the modified input 502. The pipeline can generate the real-time depth mesh 336 based on the depth map 332 and the template mesh 334. The real-time depth mesh 336 can be used by the local computing device 102, server 116, and/or remote computing device 118 to generate an image 338 that is a representation of the local user 104.

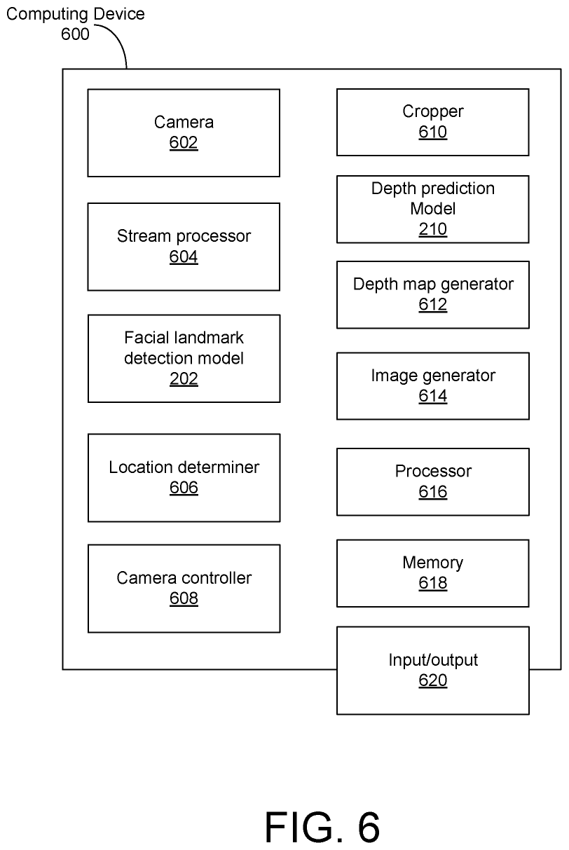

FIG. 6 is a block diagram of a computing device 600 that generates a representation 104A of the local user 104 based on the depth map 212. The computing device 600 can represent the local computing device 102, server 116, and/or remote computing device 118.

The computing device 600 can include a camera 602. The camera 602 can be an example of the camera 108 and/or the camera 124. The camera 602 can capture color images, including digital images, of a user, such as the local user 104 or the remote user 120. The representation 104B is an example of an image that the camera 602 can capture.

The computing device 600 can include a stream processor 604. The stream processor 604 can process streams of video data captured by the camera 602. The stream processor 604 can send, output, and/or provide the video stream to the facial landmark detection model 202, to a cropper 610, and/or to the depth prediction model 210.

The computing device 600 can include the facial landmark detection model 202. The facial landmark detection model 202 can find and/or determine landmarks on the representation of the face 130B of the local user 104, such as the right eye 132B, eye 134B, nose 136B, and/or mouth 138B.

The computing device 600 can include a location determiner 606. The location determiner 606 can determine a location of the face 130B within the frame 125 based on the landmarks found and/or determined by the facial landmark detection model 202.

The computing device 600 can include a camera controller 608. The camera controller 608 can control the camera 602 based on the location of the face 130B determined by the location determiner 606. The camera controller 608 can, for example, cause the camera 602 to rotate and/or change direction and/or depth of focus.

The computing device 600 can include a cropper 610. The cropper 610 can crop the image(s) captured by the camera 602. The cropper 610 can crop the image(s) based on the location of the face 130B determined by the location determiner 606. The cropper 610 can provide the cropped image(s) to a depth map generator 612.

The computing device 600 can include the depth prediction model 210. The depth prediction model 210 can determine depths of objects for which images were captured by the camera 602. The depth prediction model 210 can include a neural network, such as the neural network 308 described above.

The computing device 600 can include the depth map generator 612. The depth map generator 612 can generate the depth map 212 based on the depth prediction model 210 and the cropped image received from the cropper 610.

The computing device 600 can include an image generator 614. The image generator 614 can generate the image and/or representation 214 that will be sent to the remote computing device 118. The image generator 614 can generate the image and/or representation 214 based on the depth map 212 generated by the depth map generator 612 and a video stream and/or images received from the camera 602.

The computing device 600 can include at least one processor 616. The at least one processor 616 can execute instructions, such as instructions stored in at least one memory device 618, to cause the computing device 600 to perform any combination of methods, functions, and/or techniques described herein.

The computing device 600 can include at least one memory device 618. The at least one memory device 618 can include a non-transitory computer-readable storage medium. The at least one memory device 618 can store data and instructions thereon that, when executed by at least one processor, such as the processor 616, are configured to cause the computing device 600 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing device 600 can be configured to perform, alone, or in combination with computing device 600, any combination of methods, functions, and/or techniques described herein.

The computing device 600 may include at least one input/output node 620. The at least one input/output node 620 may receive and/or send data, such as from and/or to, a server, and/or may receive input and provide output from and to a user. The input and output functions may be combined into a single node, or may be divided into separate input and output nodes. The input/output node 620 can include, for example, a microphone, a camera, a display such as a touchscreen, a speaker, a microphone, one or more buttons, and/or one or more wired or wireless interfaces for communicating with other computing devices.

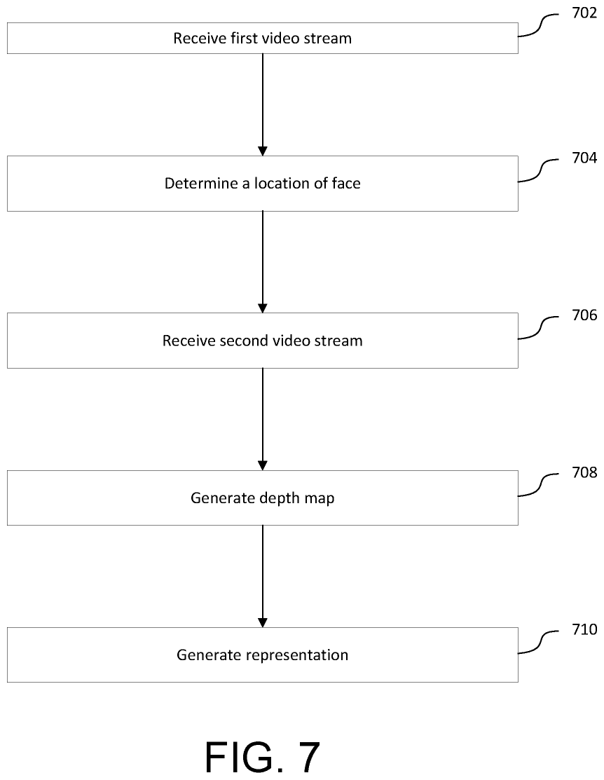

FIG. 7 is a flowchart showing a method performed by a computing device. The method may be performed by the local computing device 102, server 116, and/or the remote computing device 118. The method can include receiving, via a camera, a first video stream of a face of a user (702). The method can include determining a location of the face of the user based on the first video stream and a facial landmark detection model (704). The facial landmark detection model can be a computer model included in the local computing device and/or the server and can be adapted to determine a location of the face within the frame and/or first video stream. The facial landmark detection model can determine a location of the face based on facial landmarks, which can also be referred to as facial features of the user. The method can include receiving, via the camera, a second video stream of the face of the user (706). The method can include generating a depth map based on the second video stream, the location of the face of the user, and a depth prediction model (708). The depth prediction model can be adapted to choose from the second video stream, for example from the RGB image input of the second video stream, a scalar depth value for each pixel. These values can be then normalized, for example between 0 and 255 for RGB image input, and visualized as grayscale images where lighter pixels are understood as closer and darker pixels as farther away. The depth map can include distances of portions of the user from the camera, such as for example corresponding distances for each pixel or for a group of pixels of the second video stream depicting the user. The method can include generating a representation of the user based on the depth map and the second video stream (710).

In some examples, the depth prediction model was trained based on comparing depth data based on images captured by a depth camera to color data based on images captured by a color (RGB) camera. The images captured by the depth camera can be the same images, and/or images of the same person and/or object at the same time, as the images captured by the color (RGB) camera.

In some examples, the first video stream includes color data, and the second video stream includes color data.

In some examples, the second video stream does not include depth data.

In some examples, at least one frame included in the first video stream is included in the second video stream.

In some examples, the generating the depth map includes cropping the second video stream based on the location of the face of the user.

In some examples, the generating the representation includes generating a representation of the user and an object held by the user based on the depth map and the second video stream.

In some examples, the method is performed by a local computing device, and the camera is included in the local computing device.

In some examples, the method is performed by a server that is remote from a local computing device, and the camera is included in the local computing device.

In some examples, the method further comprises determining whether to adjust the camera based on the location of the face of the user.

In some examples, the method further comprises adjusting the camera based on the location of the face of the user.

In some examples, the method further comprises sending the representation of the user to a remote computing device.

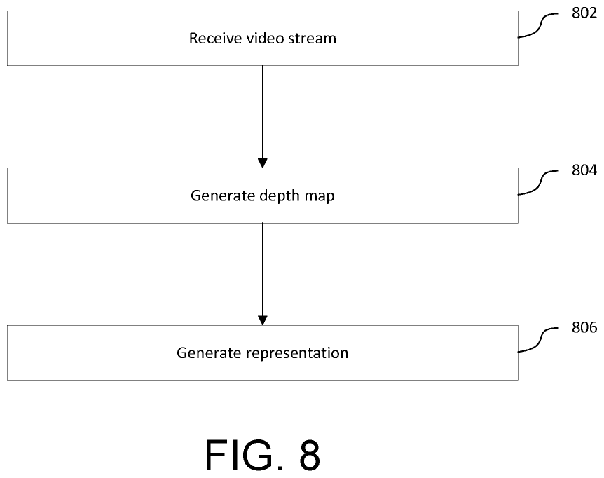

FIG. 8 is a flowchart showing another method performed by a computing device. The method may be performed by the local computing device 102, server 116, and/or the remote computing device 118. The method can include receiving, via a camera, a video stream of a face of a user (802). The method can include generating a depth map based on the video stream, a location of the face of the user, and a neural network (804). The method can include generating a representation of the user based on the depth map and the video stream (806)

In some examples, the depth map includes distances of portions of the user from the camera.

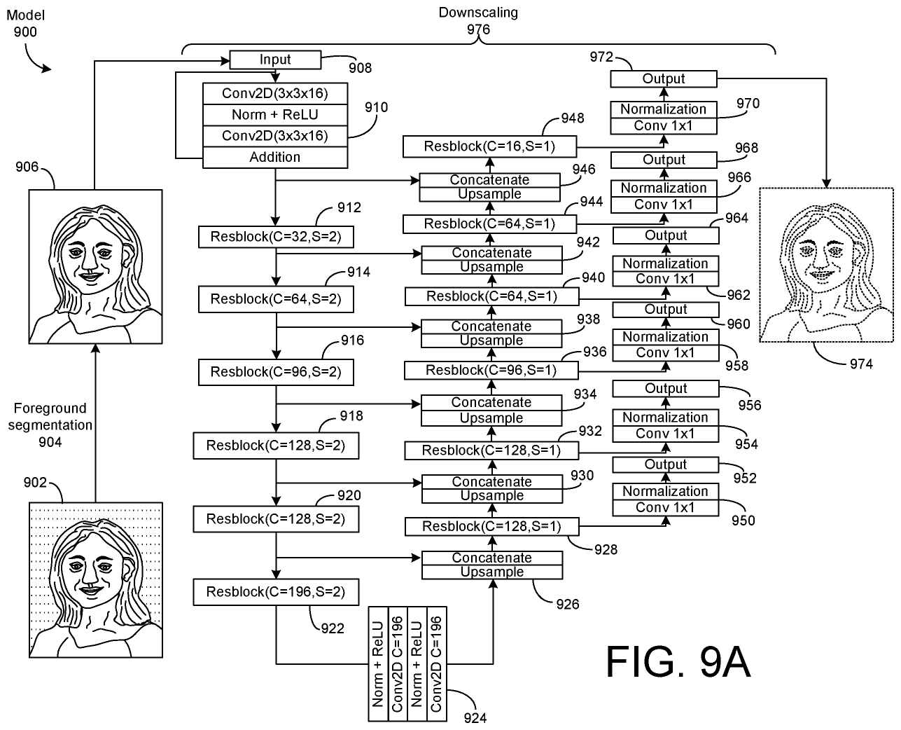

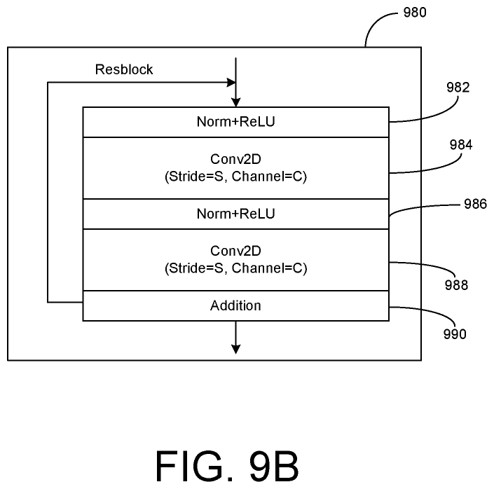

FIG. 9A shows a portrait depth estimation model 900. The portrait depth estimation model 900 reduces a data size of the representation of the user. The portrait depth estimation model 900 can be included in the computing device 600 described with reference to FIG. 6. The portrait depth estimation model 900 reduces a data size of the representation of the user before sending the representation of the user to the remote computing device. Reducing the data size of the representation of the user reduces the data sent between the computing device and the remote computing device.

The portrait depth estimation model 900 performs foreground segmentation 904 on a captured image 902. The captured image 902 is an image and/or photograph captured by a camera included in the computing device 600, such as the camera 108, 124, 602. The foreground segmentation 904 can be performed by a body segmentation module. The foreground segmentation 904 includes removing a background from the image and/or photograph of the user captured by the camera. The foreground segmentation 904 segments the foreground by removing the background from the captured image 902 so that the foreground is remaining. The foreground segmentation 904 can have similar features to the foreground segmentation that generates the modified input 502 based on the cropped input 306, as discussed above with respect to FIG. 5. The foreground is the portrait (face, hair, and/or bust) of the user. The foreground segmentation 904 results in a cropped image 906 of the user. The cropped image 906 includes only the image of the user, without the background.

After performing the foreground segmentation 904, the portrait depth estimation model 900 performs downscaling 976 on the cropped image 906 to generate a downscaled image 974. The downscaling can be performed by a deep learning method such as U-Net. The downscaled image 974 is a version of the cropped image 906 that includes less data to represent the image of the user than the captured image 902 or cropped image 906.

The downscaling 976 can include receiving the cropped image 906 as input 908. The input 908 can be provided to a convolution module 910. The convolution module 910 can iteratively perform convolution, normalization, convolution (a second time), and addition on the input 908.

The output of the convolution module 910 can be provided to a series of residual blocks (Resblock) 912, 914, 916, 918, 920, 922 and to concatenation blocks 926, 930 934, 938, 942, 946. A residual block 980 is shown in greater detail in FIG. 9B. The residual blocks 912, 914, 916, 918, 920, 922, as well as residual blocks 928, 932, 936, 940, 944, 948 either perform weighting operations on values within layers or skip the weighting operations and provide the value to a next layer.

After the values of the input 908 have passed through the residual blocks 912, 914, 916, 918, 920, 922, the resulting values are provided to a bridge 924. The bridge 924 performs normalization, convolution, normalization (a second time), and convolution (a second time) on the values received from the residual blocks 912, 914, 916, 918, 920, 922. The residual blocks 912, 914, 916, 918, 920, 922 also provide their respective resulting values to the concatenation blocks 926, 930 934, 938, 942. The values of the residual blocks 928, 932, 936, 940, 944, 948 are provided to normalization blocks 950, 954, 958, 962, 966, 970, which generate outputs 952, 956, 960, 964, 968, 972. The final output 972 generates the downscaled image 974.

FIG. 9B shows a resblock 980, included in the portrait depth estimation model of

FIG. 9A, in greater detail. The resblock 980 is an example of the residual blocks 912, 914, 916, 918, 920, 922, 928, 932, 936, 940, 944, 948. The residual block 980 can include a normalization block 982, convolution block 984, normalization block 986, convolution block 988, and addition block 990. The 980 can perform normalization, convolution, normalization, convolution (a second time), and addition, or skip these operations and provide an output value that is equal to the input value.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network

(LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
receiving, via a camera, a first video stream of a face of a user;
determining a location of the face of the user based on the first video stream and a facial landmark detection model;
receiving, via the camera, a second video stream of the face of the user;
generating a depth map based on the second video stream, the location of the face of the user, and a depth prediction model; and
generating a representation of the user based on the depth map and the second video stream.

2. The method of claim 1, wherein the depth prediction model was trained based on comparing depth data based on images captured by a depth camera to color data based on images captured by a color camera.

3. The method of claim 1, wherein:
the first video stream includes color data; and
the second video stream includes color data.

4. The method of claim 1, wherein the second video stream does not include depth data.

5. The method of claim 1, wherein at least one frame included in the first video stream is included in the second video stream.

6. The method of claim 1, wherein the generating the depth map includes cropping the second video stream based on the location of the face of the user.

7. The method of claim 1, wherein the generating the representation of the user includes cropping the second video stream based on the location of the face of the user.

8. The method of claim 1, wherein the generating the representation includes generating a representation of the user and an object held by the user based on the depth map and the second video stream.

9. The method of claim 1, wherein:
the method is performed by a local computing device; and
the camera is included in the local computing device.

10. The method of claim 1, wherein:
the method is performed by a server that is remote from a local computing device; and
the camera is included in the local computing device.

11. The method of claim 1, further comprising determining whether to adjust the camera based on the location of the face of the user.

12. The method of claim 1, further comprising adjusting the camera based on the location of the face of the user.

13. The method of claim 1, further comprising sending the representation of the user to a remote computing device.

14. The method of claim 13, further comprising, before sending the representation of the user to the remote computing device, reducing a data size of the representation of the user.

15. A method comprising:
receiving, via a camera, a video stream of a face of a user;
generating a depth map based on the video stream, a location of the face of the user, and a neural network; and
generating a representation of the user based on the depth map and the video stream.

16. The method of claim 15, wherein the depth map includes distances of portions of the user from the camera.

17. A non-transitory computer-readable storage medium comprising instructions stored thereon that, when executed by at least one processor, are configured to cause a computing device to:
receive, via a camera, a first video stream of a face of a user;
determine a location of the face of the user based on the first video stream and a facial landmark detection model;
receive, via the camera, a second video stream of the face of the user;
generate a depth map based on the second video stream, the location of the face of the user, and a depth prediction model; and
generate a representation of the user based on the depth map and the second video stream.

18. The non-transitory computer-readable storage medium of claim 17, wherein the depth prediction model was trained based on comparing depth data based on images captured by a depth camera to color data based on images captured by a color camera.

19. A computing device comprising:
at least one processor; and
a non-transitory computer-readable storage medium comprising instructions stored thereon that, when executed by the at least one processor, are configured to cause the computing device to:
receive, via a camera, a first video stream of a face of a user;
determine a location of the face of the user based on the first video stream and a facial landmark detection model;
receive, via the camera, a second video stream of the face of the user;
generate a depth map based on the second video stream, the location of the face of the user, and a depth prediction model; and
generate a representation of the user based on the depth map and the second video stream.

20. The computing device of claim 19, wherein the instructions are further configured to cause the computing device to:
reduce a data size of the representation of the user; and
send the representation of the user to a remote computing device.
